(19) United States
(12) Patent Application Publication
(10) Pub. No.: US 2025/0090982 A1
(43) Pub. Date: Mar. 20, 2025

(54) METHOD AND DEVICE FOR FILTER RESIDUE TREATMENT

(71) Applicant: PLANETCARE D.O.O., Ljubljana (SI)

(72) Inventors: Miha FLISEK, Zagorje ob Savi (SI); Miha VRHOVEC, Horjul (SI)

(21) Appl. No.: 18/725,568

(22) PCT Filed: Nov. 24, 2022
(86) PCT No.: PCT/EP2022/083117

§ 371 Date: Jun. 28, 2024

(30) Foreign Application Priority Data
Jan. 4, 2022 (DE) 10 2022 100 109.1

(51) Int. Cl. B01D 29/82; B01D 29/27; B01D 29/35; B01D 29/56; B01D 29/62; B01D 37/00; C02F 1/00; C02F 11/122; C02F 11/128; C02F 103/00; D06F 39/10

(52) U.S. Cl. CPC B01D 29/822; B01D 29/27; B01D 29/35; B01D 29/56; B01D 29/62; B01D 37/00; C02F 1/001; C02F 11/122; C02F 11/128; D06F 39/10; B01D 2201/202; C02F 2103/002; C02F 2307/12

(57) ABSTRACT

The present invention provides to a filter residue treatment device, comprising a means for supplying a pressurized fluid, a housing comprising a) a first inlet for the introduction of a medium different from the pressurized fluid and comprising a filter residue and b) a second inlet for the introduction of the pressurized fluid and an inflatable or flexible means comprised in the housing and configured and arranged for being operated by the pressurized fluid such that in an inflated or flexed state it pushes the filter residue comprised in the medium introduced through the inlet towards a filter means.

### FIELD OF INVENTION

The present invention relates to the field of filter technology and, in particular, to the treatment of filter residues.

### BACKGROUND OF THE INVENTION

Filtration of liquids containing suspended particles (unfiltrates) is of importance in a great variety of applications. Contaminants that are to be separated from the liquids by means of filtration may comprise particles of different sizes, shapes and compositions that can rapidly clog the filter during the filtering operation. One approach through which clogging of the filter can be prevented is to use a self-cleaning filter that will regularly discharge the residue captured by the filter. The residue may consist of a concentrated suspension of contaminants in a liquid. Treatment of the concentrated suspension is particularly addressed herein.

For example, in the context of microfibre filtration of washing wastewater, a filter residue is discharged from the filter of the washing machine in the form of a (water) sludge with a variable density and a typical composition of wastewater, fine particles, specifically microfibers and microplastics, detergents and dirt by cleaning of (self-cleaning) the filter. Furthermore, the water sludge may contain materials such as cotton and other natural fibers, which effectively absorb water. These fibers increase in volume and, when agglomerated or layered, form a strong barrier for the water contained in the sludge, thus preventing any passive straining of the water. To securely dispose the filtered contaminants, an effective, economic as well as environmentally acceptable processing of the water sludge preferably comprising controlled de-watering and compacting of the same is required.

In view of the above, it is an object of the present disclosure to provide techniques for treating filter residues, in particular, a water sludge accumulating during a wash cycle of a washing machine.

### DESCRIPTION OF THE INVENTION

The present invention addresses the above-mentioned object by providing a filter residue treatment device that, in particular, is able to partially dry filter residue, compact it and, if needed, provide short-to-medium term storage of the treated residue. Such a filter residue treatment device comprises a housing, a means for supplying a pressurized fluid and an inflatable or flexible means comprised in the housing.

The housing comprises a first inlet for the introduction of a medium (unfiltrate) different from the pressurized fluid and comprising a filter residue (resulting from a preceding filtering process, in particular and the cleaning of a filtering device used for a preceding filtering process) and a second inlet for the introduction of the pressurized fluid. The inflatable or flexible means is configured and arranged for being operated by the pressurized fluid such that in an inflated or flexed state it pushes the filter residue comprised in the medium introduced through the first inlet towards a filter means. Operation by the pressurized fluid may comprise (directly) mechanically contacting the inflatable or flexible means for inflation or flexing. The inflatable or flexible means may be or comprise a tube, a membrane or a balloon.

The filter residue treatment device may also comprise a filtering means and it may also comprise attachment means for connecting the device to input/output connections provided for attachment of the filter residue treatment device to another device using the filter residue treatment device.

The medium treated by the device can be a water sludge, in particular, a water sludge resulting from cleaning of a filter device of a washing machine, for example, a common household washing machine. In this case, the filter residue to be treated comprises microfibers and microplastics that have to be prevented from entering the environment.

The thus configured filter residue treatment device allows for efficient de-watering (or removal of other liquid when applicable) and compacting the filter residue comprised in the medium entering the filter residue treatment device. The compacted residue can be readily removed from the device after the operation time period of the filter residue treatment device and disposed.

The filter means may be comprised in the filter residue treatment device and the filter means may be or comprise a filter bag or filter mesh. The filter bag may comprise a porous material made of natural or artificial materials, either organic or inorganic, including paper, fibrous structures or non-woven textiles.

The housing may be made of or may comprises a porous materials and/or it may comprise openings. The drained liquid separated from the filter residue (suspension) by the filter means and the operation of the inflatable or flexible means can leave the housing through the pores and/or openings and it can be collected to be discharged or recycled for further use.

The pressurized fluid can be a liquid, for example water, or a gas, for example, air. According to an embodiment, the means for supplying the pressurized fluid comprises a fresh water supply, a water pump or an air pump.

The above-described examples of the inventive filter residue treatment device can be suitably used for a washing machine or another device comprising a filter from which a filter residue suspension is expelled. The housing of the filter residue treatment device may, thus, be configured to be arranged in a washing machine. Particularly, the filter residue treatment device may further comprise a tube wherein the housing is arranged. Cleaned water leaving the housing can be collected in the tube and supplied (through an outlet comprised in the tube) to any destination that is considered appropriate, for example, to a drain pump or drum of a washing machine.

According to the invention, the filter residue treatment device comprises the inflatable or flexible means that is configured for pushing in an inflated or flexed state the filter residue towards the filter means. It may also be configured for pushing the filter means towards the housing. Thereby, efficiency of drying and compacting of the residue by the inflatable or flexible means may be increased significantly.

According to one embodiment, the filter residue treatment device further comprises a straining cup arranged in the housing and configured for accommodating the filter means. By operation of the inflatable or flexible means the filter bag can be pushed against the straining cup. The residue is compacted and water can be pressed through openings of the straining cup and removed through an outlet of the housing.

In another embodiment wherein the filter residue treatment device comprises the straining cup, the housing may be configured to be accommodated in a drawer of a washing machine or in at least a part of a drawer of a washing machine. Handling of the filter residue treatment device can be facilitated by positioning it in a drawer that can be conveniently opened and closed by a user of the washing machine.

Furthermore, it is provided a washing machine comprising the filter residue treatment device according to one of the above-described examples.

The above-mentioned object (providing techniques for treating filter residues) is also addressed by providing a method of treating a filter residue by means of the filter residue treatment device according to one of the above-described examples, comprising the following steps preformed in the given order: introducing (through the first inlet) an unfiltrate comprising the filter residue into the housing, filtering the unfiltrate by the filter means to capture the filter residue at the filter means and inflating or flexing the inflatable or flexible means (by the pressurized fluid introduced through the second inlet) to push the captured filter residue towards the filter means to compact the captured filter residue. The filter residue results from a previously performed filtering process by a filter device different from the filter means comprised in the filter residue treatment device. Thus, the method may comprise filtering another unfiltrate by another filter device/means (particularly, not being part of the filter residue treatment device) and cleaning the other filter device/means to obtain the unfiltrate comprising the filter residue.

According to an embodiment, the method comprises repeating the steps of introducing an unfiltrate, filtering the unfiltrate and inflating or flexing the inflatable or flexible means until a capacity of the filter means (for example, the filling capacity of a filter bag) is reached and, subsequently, removing filter residues accumulated in or at the filter means from the filter residue treatment device. Thus, the filter means can be used for several cycles of filtering unfiltrates and compacting filter residues before it will be cleaned or disposed, for example.

The method according to the above-describe examples may be implemented in a washing machine and the other filter device may be a common self-cleaning filter of the washing machine.

Additional features and advantages of the present invention will be described with reference to the drawings. In the description, reference is made to the accompanying figures that are meant to illustrate exemplary embodiments of the invention. It is understood that such embodiments do not represent the full scope of the invention.

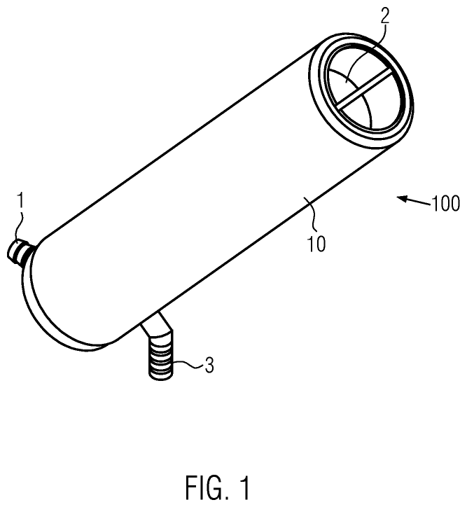

FIG. 1 is an isometric view schematically illustrating a filter residue treatment device comprising a housing arranged in a tube according to an embodiment of the present invention.

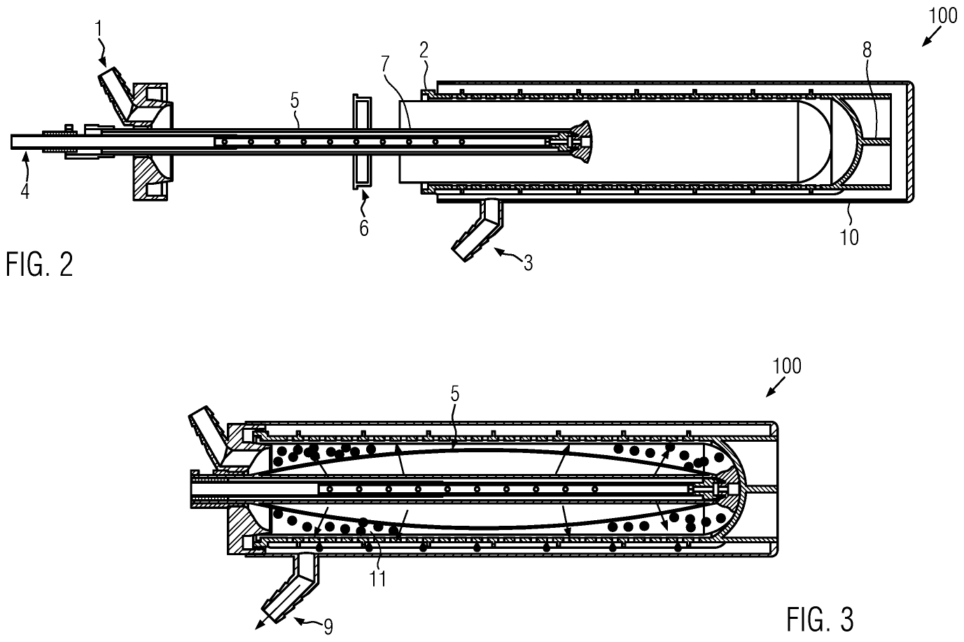

FIGS. 2 and 3 are sectional views further illustrating the filter residue treatment device shown in FIG. 1 in different operation stages.

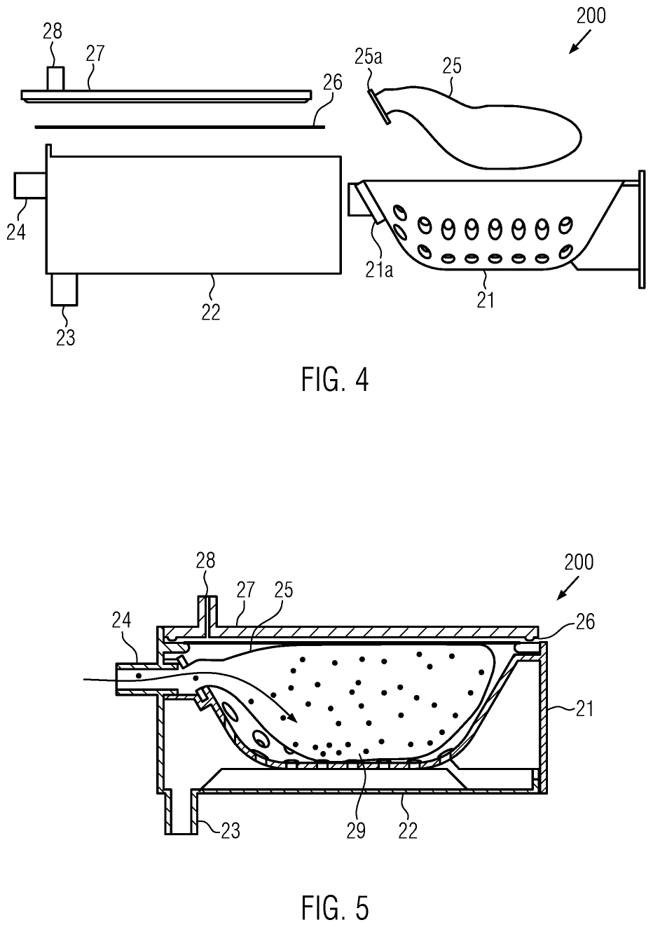

FIG. 4 is an exploded view illustrating a filter residue treatment device comprising a straining cup according to another embodiment of the present invention.

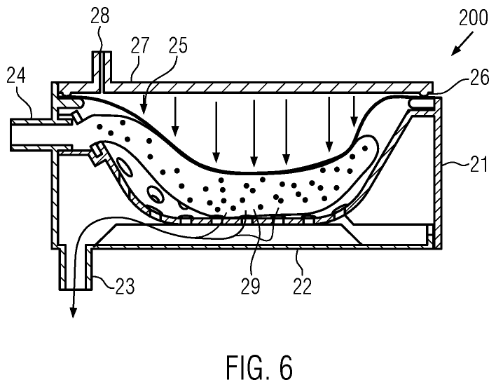

FIGS. 5 and 6 are sectional views further illustrating the filter residue treatment device shown in FIG. 4 in different operation stages.

The present invention provides a filter residue treatment device for compacting a filter residue. The filter residue results from some filtering process applied to a previous unfiltrate and is supplied to the filter residue treatment device within a liquid, for example, water, for further processing. The liquid comprising the filter residue in itself represents an unfiltrate to be treated by the filter residue treatment device.

The invention is, particularly, applicable to the treatment of filter residues accumulating at a (self-cleaning) filter device installed in a washing machines. During a self-cleaning process of the filter device, for example, the filter residue is washed out and the resulting water sludge can be treated by the filter residue treatment device according to the present invention.

FIG. 1 shows a filter residue treatment device 100 according to an embodiment that is applicable to a washing machine, in particular, a common household washing machine. Other applications are expressly not excluded. The filter residue treatment device 100 comprises a housing 2 comprising an inlet 1 through which a water sludge can be introduced into the housing 2. For example, the water sludge can be introduced into the housing 2 by means of a pump. The housing 2 can be arranged in a tubular geometric form and may be a tube 10. Within the housing 2 the water sludge is treated such that the filter residue comprised in the water sludge is compacted. The housing 2 comprises openings or pores and the drained water leaving the housing 2 through the opening or pores is collected in the tube 10 and can leave the filter residue treatment device 100 through an outlet 3 comprised in the tube 10. The clean water leaving the filter residue treatment device 100 through the outlet 3 can be supplied to a drain pump or returned to a washing machine drum, for example.

FIGS. 2 and 3 show some more details of the filter residue treatment device 100 shown in FIG. 1 in cross sectional views in a first operation stage and a second operation stage following the first one, respectively. The water sludge is introduced into the housing 2 through the inlet 1 and enters a filter bag 7 provided in the housing 2 and held by a filter bag holder 6. The filter bag 7 may be made of a woven or non-woven fabric, for example. The water sludge is filtered by the filter bag 7 and the filtered water leaves the housing 2 through the openings or pores of the housing, is collected in the tube and leaves the filter residue treatment device 100 through the outlet 3. Meanwhile, the filter residue comprised in the introduced water sludge is collected in the filter bag 7 in the first operation stage.

Furthermore, the filter residue treatment device 100 comprises an inflatable means 5 that is connected to a pressure inlet 4 for introducing a pressurized fluid. The inflatable means 5 may be or comprise a tube or a balloon (balloon-like insert) or other suitable form made of a flexible membrane. In the second operation stage, the inflatable means 5 is inflated by a pressurized fluid introduced through the pressure inlet 4 (see FIG. 3). The pressurized fluid may be pressurized water supplied by a fresh water supply of the washing machine. Alternatively or additionally, a water pump or an air pump may be provided to supply the pressurized fluid to the filter residue treatment device 100 in order to inflate the inflatable means 5.

While the inflatable means 5 is inflating, it decreases the available volume inside the housing 2 and, thus, pushes the water content of the remaining water sludge through the filtering material of the filter bag 7. By pressing the residue 11 against the filter bag 7, the residue 11 (mainly microfibers and microplastics filtered out by a self-cleaning filter device of the washing machine) is at the same time de-watered and compacted. The pressurized inflating inflatable means 5 will completely fill all the available space, pressing against both the filter bag 7 and the housing 2. Thus, (almost) all the water is displaced out of the filter bag 7 and the housing 2 through the openings or pores provided therein. Since that water has to move through the forming deposit cake and the filter bag, it is clean in that it does not contain any solid residue 11 and it can be returned to the washing machine drum for further usage, for example.

After some operation cycles, the filter bag capacity of the filter bag 7 will be reached. Removal of the residue can be performed by unscrewing the housing 2 by means of a handle 8 from the washing machine and removing the filter bag 7. The filter bag can then be replaced with an empty one, if it is a disposable bag or, alternatively, it can be cleaned and re-installed for further use. Since the solid residue 11 is compacted by the expanding inflatable means 5, the amount of residue 11 that is stored in the available volume of the filter bag 7 can be maximized. The interval between removals of filter bags 7 containing compacted residues is therefore maximized and user intervention is minimized.

In the above-described embodiment, the inflatable means 5 may be replaced by a flexible means, for example, a membrane, that is flexed against the filter bag 7 by the pressurized liquid in order to push the filter residue against the filter bag 7 and the housing 2 of the filter residue treatment device 100.

Another embodiment of an inventive filter residue treatment device 200 is illustrated in FIGS. 4, 5 and 6. The filter residue treatment device 200 according to this embodiment is suitable to be accommodated in a drawer of a washing machine, for example, a common household washing machine. This drawer may, for example, be provided separately from or attached to a common drawer used for washing detergents. The embodiment serves to illustrate a possible form of the invention but in no way excludes other applications and modalities.

The filter residue treatment device 200 illustrated in FIGS. 4, 5 and 6 comprises a straining cup 21 comprising openings. The straining cup 21 can be accommodated in a housing 22. The housing 22 may be configured to be inserted into a drawer of a washing machine or it may represent a drawer or part of drawer of a washing machine. The housing 22 comprises an outlet 23 for letting out drained water and an inlet 24 for the introduction of a water sludge and it can be otherwise solid without any pores or further openings. A filter bag 25 (made of a woven or non-woven fabric or a durable synthetic fabric, for example) can be accommodated in the straining cup 21. The straining cup 21 together with the filter bag 25 that stores the compacted filter residue introduced with a water sludge supplied to the filter residue treatment device 200 can be removed from (after the capacity of the filter bag 25 has been reached) and inserted into (at the beginning of an operation cycle) the housing 22. In an operational position, a neck 25a of the filter bag 25 is coupled to a mating receptacle 21a provided in the straining cup 21 and the inlet 24 of the housing 22 such that an incoming water sludge is directly received by the filter bag 25.

Furthermore, the filter residue treatment device 200 comprises a flexible means 26, for example, a flexible membrane, arranged below a cover 27. The cover 27 may be (a part of) a cover provided for a drawer of a washing machine, for example, or it may be a separate cover. In any case, the cover 27 comprises a pressure inlet 28 for the introduction of a pressurized fluid.

FIGS. 5 and 6 show cross sectional views of the filter residue treatment device 200 in a first operation stage and a second operation stage following the first one, respectively. In the first operation stage, a water sludge resulting from the cleaning of a filter device comprised in the washing machine flows inside the filter residue treatment device 200 through the inlet 24 of the housing 22 and the solid particulate filter residue 29 comprised in the water sludge is captured inside the filter bag 25 whereas the water is drained through the filter bag 25 and the straining cup 21 and flows back to the washing machine drum through the outlet 23. In the first operation stage, the filter bag 25 is filled with the water sludge and, therefore, occupies the entire available volume of the straining cup 21 (see FIG. 5).

In the second operation stage shown in FIG. 6, the residue 29 is further de-watered and compacted and the remaining water content is drained out of the filter bag 25 by operation of the flexible means 26. The flexible means 26 can be a membrane and it is flexed/actuated by means of either pressurized water from the fresh water supply already available in the washing machine or water or air supplied by a water or air pump that can generate sufficient pressure to drain the water out of the residue 29. In either case, the pressurized fluid is supplied through the pressure inlet 28 of the cover 27. While the flexible means 26 is flexed, it presses downwards (as indicated by the arrows in FIG. 6) thereby decreasing the available volume of the filter bag 25 and pushes the water content of the water residue through the filter bag 25 and through the outlet 23 out of the housing 22 of the filter residue treatment device 200.

By pressing the residue 29 against the wall of the filter bag 25 and towards the straining cup 21, the residue 29 is at the same time de-watered and compacted. When the filter bag 25 is full, the user will pull out the drawer or drawer-type movable subassembly of the straining cup 21 together with the filter bag 25 accommodated therein, remove the filter bag 25 from the straining cup 21 and either clean it (in case of a reusable type) or replace it with a new one in case it is designed as a consumable, replaceable part. In the latter case, the user does not need to handle the actual solid waste collected in the filter bag 25 and the filter bag exchange process can be kept clean and simple.

A new or cleaned filter bag can be reinstalled simply by inserting a bag neck of a new filter bag or the bag neck 25 of the cleaned filter bag 25 into the mating receptacle 21a provided in the straining cup 21. The drawer subassembly could be a part of an already existing detergent drawer (as a standard part of a washing machine), located either parallel or in the back of the existing detergent drawer or it can be part of an additional drawer that is exclusively provided for accommodation and operation of the filter residue treatment device 200.

In the embodiment described above with reference to FIGS. 4, 5 and 6, the flexible means 26 may be replaced by an inflatable means, for example, a tube or balloon that is inflated by the supplied pressurized liquid to press against the filter bag 25 and towards the straining cup 21.

All previously discussed embodiments are not intended as limitations but serve as examples illustrating features and advantages of the invention. It is to be understood that some or all of the above-described features can also be combined in different ways.

1. A filter residue treatment device, comprising:
a means for supplying a pressurized fluid;
a housing comprising:
a first inlet for introduction of a medium that is different from the pressurized fluid and including a filter residue; and
a second inlet for introduction of the pressurized fluid; and
an inflatable or flexible means arranged in the housing and configured to being operated by the pressurized fluid such that in an inflated or flexed state, the inflatable or flexible means pushes the filter residue included in the medium and introduced through the first inlet towards a filter means; and
wherein the housing is configured to be arranged in a washing machine.

2. The filter residue treatment device according to claim 1, wherein the inflatable or flexible means is or comprises at least one of a flexible and elastic tube; a balloon; or a membrane.

3. (canceled)

4. The filter residue treatment device according to claim 1 wherein the filter means is provided in the filter residue treatment device.

5. The filter residue treatment device according to claim 1, wherein the filter means includes a filter bag or a filter mesh.

6. The filter residue treatment device according to claim 1, wherein the housing comprises at least one of openings or is made of a porous material.

7. The filter residue treatment device according to claim 1, wherein the means for supplying the pressurized fluid comprises at least one of a fresh water supply; a water pump; or an air pump.

8. (canceled)

9. The filter residue treatment device according to claim 1, further comprising a tube comprising an outlet, and wherein the housing is arranged in the tube.

10. The filter residue treatment device according to claim 1, wherein the inflatable or flexible means is configured for pushing the filter means towards the housing.

11. The filter residue treatment device according to claim 1 further comprising a straining cup arranged in the housing and configured for accommodating the filter means.

12. The filter residue treatment device according to claim 11, wherein the housing is configured to be accommodated in a drawer of a washing machine or is at least a part of a drawer of a washing machine.

13. The filter residue treatment device according to claim 11, wherein the inflatable or flexible means is configured for pushing the filter means towards the straining cup.

14. A washing machine comprising the filter residue treatment device according to claim 1.

15. A method of treating a filter residue by means of the filter residue treatment device according to claim 1, comprising:
filtering an unfiltrate by a filter device and cleaning the filter device to obtain another unfiltrate comprising filter residue;
introducing the other unfiltrate comprising the filter residue into the housing;
filtering the other unfiltrate by a filter means different from the filter device to capture the other filter residue at the filter means; and
inflating or flexing the inflatable or flexible means to push the captured other filter residue towards the filter means to compact the captured other filter residue.

16. (canceled)

17. The method according to claim 15, comprising repeating the steps of introducing another unfiltrate, filtering the other unfiltrate and inflating or flexing the inflatable or flexible means are repeated until a capacity of the filter means is reached and, subsequently, removing filter residue accumulated in or at the filter means from the filter residue treatment device.
